(19) United States
(12) Patent Application Publication
(10) Pub. No.: US 2007/0263848 A1
(43) Pub. Date: Nov. 15, 2007

(54) Echo detection and delay estimation using a pattern recognition approach and cepstral correlation

(75) Inventor: Rafid A. Sukkar, Aurora, IL (US)

Correspondence Address: FITZPATRICK CELLA HARPER & SCINTO, 30 ROCKEFELLER PLAZA, NEW YORK, NY, 10112, US

(73) Assignee: TELLABS OPERATIONS, INC., NAPERVILLE, IL (US)

(21) Appl. No.: 11/406,458

(22) Filed: Apr. 19, 2006

(51) Int. Cl. H04M 9/08

(52) U.S. Cl. 379/406.01

(57) ABSTRACT

A method, apparatus, system, and program, for evaluating communication signals exchanged between communicating devices through at least one communication path. The method comprises performing a similarity function or distance function to determine if the communication signals include at least one substantially similar pattern, and reporting an existence of a predetermined condition if it is determined in the performing that the communication signals include a substantially similar pattern. The predetermined condition can be, for example, an echo condition in a single talk or double talk condition, and the echo condition can be acoustical or electrical in origin. The method adapts features and techniques that have been used successfully in speech recognition for successful application in the echo detection and double talk contexts, and the similarity function preferably is based on cepstral correlation according to the invention.

### BACKGROUND OF THE INVENTION

Field of the Invention

This invention relates to a method, system, apparatus, and program for detecting acoustical and electrical echoes using a pattern recognition technique, and for determining an echo path delay.

### DESCRIPTION OF RELATED ART

The detection and suppression of acoustic echoes in telecommunication networks have become increasingly important with the widespread proliferation of wireless networks. In non speaker-phone situations, the severity of acoustic echoes depends mainly on the design and construction of the specific handset used during a given call. The design and construction of the handset casing and the placement of the mouthpiece relative to the earpiece play especially critical roles in determining the severity of such echoes. In speaker-phone cases, the placement of the speaker and microphone as well as the room acoustics are the major factors that contribute to the level of acoustic echoes introduced. Acoustic echoes also can be present in wireline networks for the same reasons outlined above. In addition, wireline networks can be prone to experiencing electrical echoes caused by an impedance mismatch at conversion hybrids, such as, for example, a 2-to-4 wire conversion hybrid, or electrical echoes caused by other types of electrical components.

In many cases, it is desirable to suppress any acoustic echoes that may be present in a voice path. In order to successfully suppress such echoes, they must first be detected, and then the corresponding echo path delay must be estimated. Echo detection and delay estimation are also important in Quality of Service (QoS) monitoring applications, in which telecommunications service providers and operators are interested in measuring the voice path quality of their networks. In these monitoring applications, echo detection needs to apply to both acoustic echoes and electrical echoes as well.

Many methods for echo detection and suppression have been proposed (see, e.g., publications [1] and [2] listed in the LIST OF REFERENCES section below). If echoes are known to be electrical, for example, then an adaptive linear filter can be used effectively to detect, as well as cancel, the echoes. In cases where acoustic echoes are to be detected and suppressed or cancelled, on the other hand, linear filtering may not produce adequate results, and thus other strategies need to be employed as described in, for example, publication [3] listed in the LIST OF REFERENCES section below. Furthermore, echoes during double-talk conditions (i.e., when two parties are speaking simultaneously into the mouthpiece of their respective user communication terminals) need to be distinguished from echoes during single-talk conditions.

There exists a need, therefore, to provide a novel method for echo detection and echo path delay estimation for acoustic echoes as well as electrical echoes, that overcomes the above-noted drawbacks of the prior art.

### SUMMARY OF THE INVENTION

The foregoing and other problems are overcome by a method for evaluating communication signals exchanged between communicating devices through at least one communication path, and also by a program, user communication device, and communication system that operate in accordance with the method.

According to an aspect of the invention, echo detection is performed using a pattern recognition technique. In accordance with this aspect of the invention, the method comprises performing a similarity function to determine if the communication signals include at least one substantially similar pattern, and reporting an existence of a predetermined condition if it is determined in the performing that the communication signals include a substantially similar pattern.

The predetermined condition can be an echo condition echo during single talk or double talk, and the echo condition can be acoustical or electrical in origin. For example, acoustical echoes can result from at least part of a communication signal being fed back into an input interface of one of the communicating devices, after having been outputted through an output interface of that communicating device. Electrical echoes, for example, can result from a communication signal interacting with an electrical hybrid component included in the at least one communication path.

According to the preferred embodiment of the invention, the method further comprises segmenting, into first frames, at least one first communication signal traveling from a first one of the communicating devices to a second one of the communicating devices through the at least one communication path. Similarly, at least one second communication signal traveling from the second one of the communicating devices to the first one of the communicating devices through the at least one communication path, is segmented into second frames. A first feature vector is formed based on at least one of the first frames, and a second feature vector is formed based on at least one of the second frames. The similarity function is performed based on the first and second feature vectors.

Preferably, the method further comprises calculating cepstral coefficients based on the at least one first frame and the at least one second frame. The forming of the first feature vector is based on cepstral coefficients calculated from the at least one first frame, and the forming of the second feature vector is based on cepstral coefficients calculated from the at least one second frame.

In a preferred embodiment of the invention, the feature vector is formed using Mel-Frequency Cepstral Coefficients, their first order derivatives and their second order derivatives, and the similarity function is defined as follows:

$${f}_{i} ( m ) = \frac{{X}_{i}^{T} {U}^{- 1} {Y}_{m}}{\vert {U}^{- 1 / 2} {Y}_{m} \vert}$$

where f(m) represents the similarity function, U is a diagonal covariance matrix, Xᵢ is a first feature vector and Yₘ is a second feature vector, and T represents a matrix transpose.

According to a further aspect of the invention, the method further comprises determining an estimated echo delay based on a result of the performing of the similarity function.

According to still a further aspect of the invention, detected echoes are reduced or substantially minimized.

In accordance with another embodiment of this invention, the method of this invention performs a predetermined distance function instead of the similarity function. For example, the distance function can be L1 or L2 norms of a difference between feature vectors, although in other embodiments other suitable distance functions can be employed.

### BRIEF DESCRIPTION OF THE DRAWINGS

The present invention will be more readily understood from a detailed description of the preferred embodiments taken in conjunction with the following figures:

FIG. 1 is a block diagram of a communication system 1 that is suitable for practicing this invention.

FIG. 2 is a block diagram of a user communication terminal that operates within the system 1 of FIG. 1 and which is equipped with the capability to detect echoes.

FIG. 3 shows one embodiment of an echo detection system that includes an echo detection module 44 that operates in accordance with a method of the invention, and components 32 and 33 of the user communication terminal of FIG. 2.

FIG. 4 shows an echo detection system according to another embodiment of the invention that includes an echo detection module 44 that operates in accordance with the method of this invention, component 33 of the user communication terminal of FIG. 2, an electrical hybrid 46, and an adder or combiner 48.

FIG. 5 shows a flow diagram of the echo detection method of this invention.

FIGS. 6 and 7 show examples of plots of similarity function values versus echo path delay, calculated based on the method depicted in FIG. 5.

FIGS. 8a to 8c show examples of the behavior of a similarity function fᵢ(m) during single-talk, double-talk, and no speech conditions.

Identically labeled elements appearing in different ones of the figures refer to the same elements but may not be referenced in the description for all figures.

### DETAILED DESCRIPTION OF THE PREFERRED EMBODIMENTS

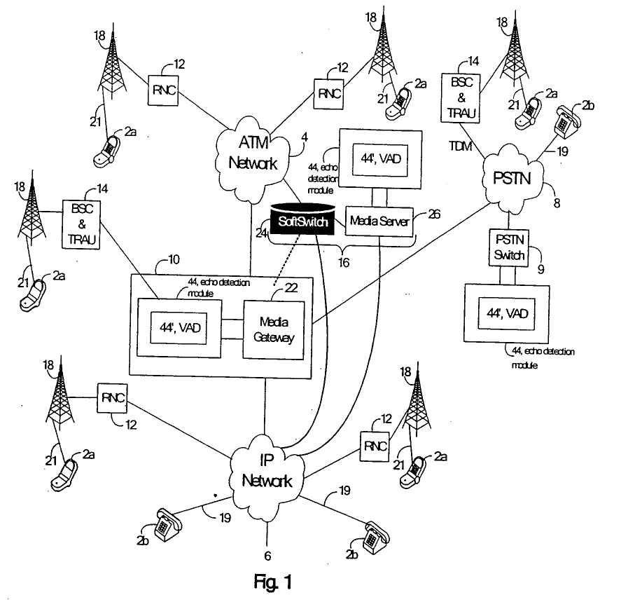

FIG. 1 is a block diagram of a communication system 1 that is suitable for practicing this invention. In the illustrated embodiment, the communication system 1 comprises a plurality of user communication terminals (devices) 2a, 2b, a plurality of communication networks 4, 6, 8, a gateway 10, and various communication and/or control stations such as, for example, Radio Network Controllers (RNCs) 12, Base station Controllers (BSCs) and Transcoder Rate Adaptor Units (TRAUs), the latter two of which are shown and referred to hereinafter collectively as BSCs/TRAUs 14, base sites or base stations 18, and an Integrated Multimedia Server (IMS) 16. Traditionally, various types of interconnecting mechanisms may be employed for interconnecting the above components as shown in FIG. 1, such as, for example, optical fibers, wires, cables, switches, wireless interfaces, routers, modems, and/or other types of communication equipment, as can be readily appreciated by one skilled in the art, although, for convenience, no such mechanisms are explicitly identified in FIG. 1, besides wireless and wireline interfaces 21 and 19, respectively.

In the illustrated embodiment, the user communication terminals 2a are depicted as cellular radiotelephones that include an antenna for transmitting signals to and receiving signals from a base station 18 responsible for a given geographical cell, over a wireless interface 21. Preferably, the user communication terminal 2a is capable of operating in accordance with any suitable wireless communication protocol, such as IS-136, GSM, IS-95 (CDMA), wideband CDMA, narrow-band AMPS (NAMPS), and TACS. Dual or higher mode phones (e.g., digital/analog or TDMA/CDMA/analog phones) may also benefit from the teaching of this invention, and so called “Voice-Over-IP” technology, such as H.323 and SIP protocols, may also benefit as well. It should thus be clear that the user communication terminal 2a can be capable of operating with one or more air interface standards, communication protocols, modulation types, and access types, and that the teaching of this invention is not limited for use with any particular one of those standards/protocols, etc.

The RNCs 12 are each communicatively coupled to a neighboring base station 18 and a corresponding network 4 or 6, and are capable of routing calls and messages to and from the user communication terminals 2a when the terminals are making and receiving calls. The RNCs 12 route such calls to the networks 6 and 4. The BSC portion of the BSCs/TRAUs 14 typically controls its neighboring base station 18 and controls the routing of calls and messages between terminals 2a and other components of the system 1 coupled bidirectionally to the respective BSC/TRAU 14, such as, for example, gateway 10 and network 8, and the TRAU portion of the BSCs/TRAUs 14 performs rate adaptation functions such as those defined in, for example, GSM recommendations 04.21 and 08.20 or later versions thereof. The base stations 18 typically have antennas to define their geographical coverage area.

According to the illustrated embodiment, network 8 is the PSTN that routes calls via one or more switches 9, the network 4 operates in accordance with Asynchronous Transfer Mode (ATM) technology, and the network 6 represents the Internet, adhering to TCP/IP protocols, although the present invention should not be construed as being limited for use only with one or more particular types of networks. Also, user communication terminals 2b are depicted as landline telephones, that are bidirectionally coupled to network 6 or 8.

The gateway 10 includes a media gateway 22 that acts as a translation unit between disparate telecommunications networks such as the networks 4, 6, and 8. Typically, media gateways are controlled by a media gateway controller, such as a call agent or a soft switch 24 which provides call control and signaling functionality, and perform conversions between TDM voice and Voice over Internet Protocol (VoIP), radio access networks of a public land network, and Next Generation Core Network technology, etc. Communication between media gateways and soft switches often is achieved by means of protocols such as, for example, MGCP, Megaco or SIP.

Media server 26 is a computer or farm of computers that facilitate the transmission, storage, and reception of information between different points, such as between networks (e.g., network 6) and soft switch 24 coupled thereto. From a hardware standpoint, a server 26 typically includes one or more components, such as one or more microprocessors (not shown), for performing the arithmetic and/or logical operations required for program execution, and disk storage media, such as one or more disk drives (not shown) for program and data storage, and a random access memory, for temporary data and program instruction storage. From a software standpoint, a server 26 typically includes server software resident on the disk storage media, which, when executed, directs the server 26 in performing data transmission and reception functions. The server software runs on an operating system stored on the disk storage media, such as, for example, UNIX or Windows NT, and the operating system preferably adheres to TCP/IP protocols. As is well known in the art, server computers can run different operating systems, and can contain different types of server software, each type devoted to a different function, such as handling and managing data from a particular source, or transforming data from one format into another format. It should thus be clear that the teaching of this invention is not to be construed as being limited for use with any particular type of server computer, and that any other suitable type of device for facilitating the exchange and storage of information may be employed instead.

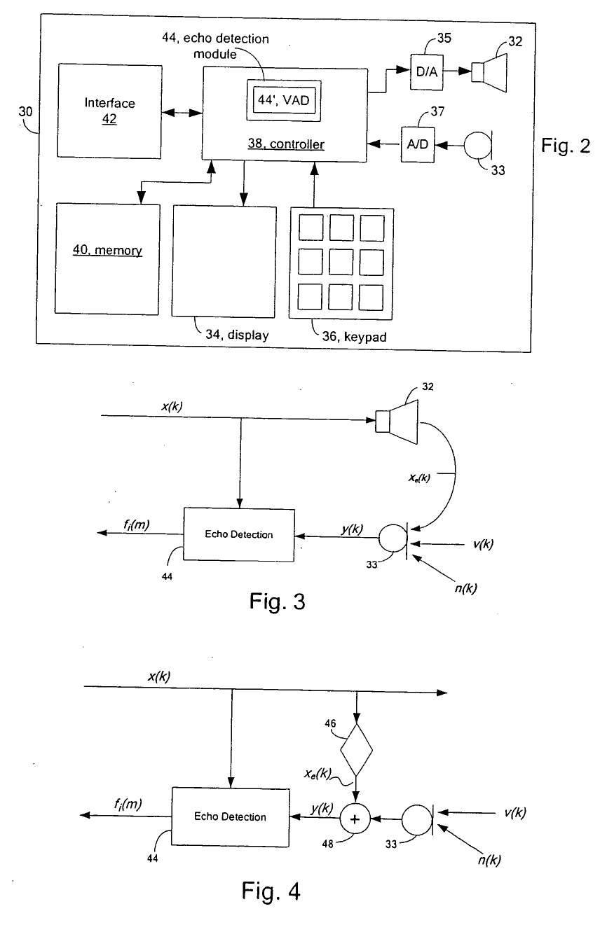

According to an aspect of the present invention, the system 1 of FIG. 1 also includes one or more echo detection modules 44 that operate in accordance with the method of this invention to detect echoes of electrical or acoustical origin. The module 44 may be provided in, for example, the gateway 10 and the IMS 16, and/or in association with the PSTN 8, as shown in the illustrated embodiment, in one or more user terminals 2a, 2b (as shown and described in connection with FIG. 2 below), at one or more predetermined locations (not shown) within the networks 4, 6, 8, or at other predetermined locations (not shown) within the system 1, such as, for example, within an RNC 14 and/or BSC/TRAU 14. Generally speaking, the specific location of a module 44 can vary depending on predetermined system design and operating criteria, so long as communications exchanged in an established call communication path can be extracted for being evaluated by the module 44 to enable it to perform the method of this invention. For example, in the illustrated embodiment, the echo detection module 44 included in gateway 10 is bidirectionally coupled to media gateway 22 and to a neighboring BSC/TRAU 14, the echo detection module 44 included in IMS 16 is bidirectionally coupled to media server 26, and the echo detection module 44 associated with PSTN 8 is bidirectionally coupled to switch 9 associated with PSTN 8. The components 22, IMS 26 and 9 can extract communication signals from established calls being carried in a communication path through the component, to the module 44 associated with the component, to enable the module 44 to perform the method of the invention to be described below, although in cases where the modules 44 are within the communication path directly, the modules 44 can extract those signals directly for performing the method. In other embodiments, the modules 44 can be integrated within the adjacent communication system element with which it communicates, such as, for example, within components 22, 26, and 9. It should be noted that although the components 9 and 44 are shown outside the network 8 in FIG. 2, in some embodiments those components 9 and 44 may be included in the network 8.

Referring now to FIG. 2, a preferred embodiment of an individual user communication terminal 2a, 2b is shown, and is identified by reference numeral 30. The user communication terminal 30 includes an interface 42 for communicatively coupling the terminal 30 to an external communication interface, such as the interface 21 (FIG. 1), in the case of user communication terminal 2a, or wireline interface 19, in the case of user communication terminal 2b. For example, the interface 42 of FIG. 2 may include a transceiver and an antenna (in the case of terminal 2a) for enabling the terminal 30 to exchange information with the external interface. That information may include, for example, signaling information in accordance with the external interface standard employed by the respective network coupled to the terminal 30, user speech, and data.

A user interface of the terminal 30 includes a conventional speaker 32, a display 34, a user input device, typically a keypad 36, and a transducer device, such as a microphone 33, all of which are coupled to a controller 38 (CPU), although in other embodiments, other suitable types of user interfaces also may be employed. The keypad 36 includes the conventional numeric (0-9) and related keys (#, *), and can include other keys that are used for operating the user communication terminal 30, such as, for example, a SEND key (terminal 2a), various menu scrolling and soft keys, etc. A digital-to-analog (D/A) converter 35 is interposed between an output of the controller 38 and an input of the speaker 32. The D/A converter 35 converts digital information signals received from the controller 38 into corresponding analog signals, and forwards those analog signals to the speaker 32, for causing the speaker 32 to output a corresponding audible signal. An analog to digital (A/D) converter 37 is interposed between an output of the microphone 33 and an input of the controller 38, and operates by repetitively sampling and then digitizing analog signals received from the microphone 33, and by providing digital audio (e.g., speech) samples representing the resulting digital values to the controller 38.

In accordance with one embodiment of the present invention, an echo detection module 44 also is included in the terminal 30, either as part of the controller 38 as shown, or separately from the controller 38 but in bidirectional communication therewith. When the user communication terminal 30 is engaged in an established call, communication signals (representing, for example, speech, other acoustic information, and/or data) that are received through the interface 42 and destined to be outputted through speaker 32, are forwarded to the controller 38 before being outputted through the speaker 32. Signals that are inputted through the microphone 33 during the call also are forwarded to the controller 38, before being transmitted to their intended destination through, for example, interface 42. Both types of signals are employed to enable the module 44 to perform the method of the invention to be described below.

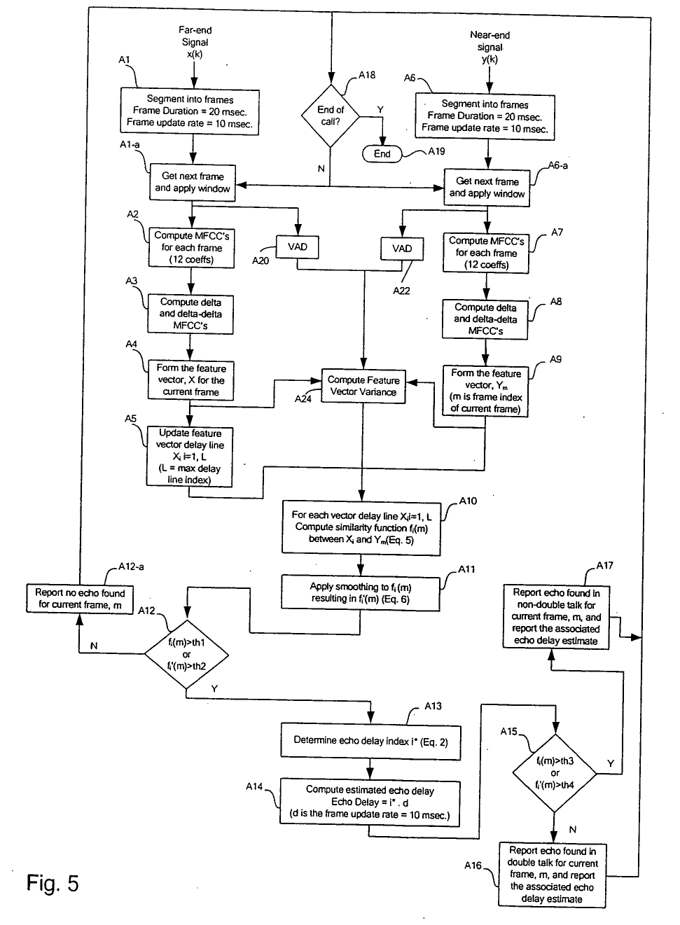

The user communication terminal 30 also includes various memories, such as a RAM, a ROM, and a Flash memory, shown collectively as the memory 40. An operating program for controlling the operation of controller 38 and module 44 also is stored in the memory 40 (typically in the ROM) of the user communication terminal 30, and may include routines to present messages and message-related functions to the user on the display 34, typically as various menu items. The operating program stored in memory 40 also includes routines for implementing a method that enables acoustic and electrical echoes in communications signals to be detected, in accordance with this invention. The method will be described below in relation to FIG. 5.

It should be noted that the total number and variety of user communication terminals which may be included in the overall communication system 1 can vary widely, depending on user support requirements, geographic locations, applicable design/system operating criteria, etc., and are not limited to those depicted in FIG. 1. Also, this invention may be employed in conjunction with any suitable types of communication protocols, including, but not limited to, for example, Internet telephony protocols, ATM telephony protocols, GSM cellular telephony protocols, and ANSI ISUP. Moreover, although in FIG. 1 the user communication terminals 2a, 2b are depicted as a radiotelephone and a conventional, non-wireless telephone, respectively, any other suitable types of user communication terminals and/or information appliances may be employed, in addition to, or in lieu of, those components. For example, in other embodiments, and where appropriate, one or more of the individual terminals 2a, 2b may be embodied as a personal digital assistant, a handheld personal digital assistant, a palmtop computer, and the like. It also should be noted that, although the invention is described in the context of the various devices 2a, 2b communicating with other components through the networks 4, 6, 8, broadly construed, the invention is not so limited. For example, one or more of the user communication devices 2a, 2b may communicate with one another through other suitable interfaces, and/or may be included within a same network. In general, the teaching of this invention may be employed in conjunction with any suitable type of communication system in which communications are exchanged between at least two points. It should thus be clear that the teaching of this invention is not to be construed as being limited for use with any particular type of user communication system, user terminal or communication protocol.

Preferably, each detection module 44 includes a Voice Activity Detector (VAD) portion 44′ to determine frames that have speech activity. The VAD used in this invention preferably is the one described in publication [8], although in other embodiments other suitable types of VADs may be employed instead, or still other types of activity detectors may be employed such as those which can detect other types of audio frames besides, or in addition to, speech. It should be noted that the inclusion of VA15 portion 44′ in the echo detection module 44, is not critical nor it is required for the proper operation of the echo detection module 44. The VAD portion 44′, if present, is used mainly to determine the variance of the feature vector. If VAD portion 44′ is not included in the module 44, then the feature vector variance can be estimated off-line on a suitable database and then used in the module 44 as a predetermined variance. However, the inclusion of VAD portion 44′ in the module 44 allows for a refined variance estimate.

Pattern Recognition

An aspect of the present invention will now be described. According to this aspect of the invention, echo detection modules 44 according to the invention can perform a function to detect electrical and acoustical echoes using an adapted pattern recognition procedure of the invention. Referring to FIGS. 3 and 4, a brief description will now be made of the procedure and its derivation, before describing the procedure in greater detail below with respect to FIG. 5.

Echo detection module 44 is further represented in the simplified diagrams depicted in FIGS. 3 and 4, wherein FIG. 3 shows one embodiment of an echo detection system that includes the module 44 and the components 32 and 33 of the user communication terminal 30 of FIG. 2, and FIG. 4 shows an echo detection system according to another embodiment of the invention that includes module 44, component 33 of FIG. 2, an electrical hybrid 46 (e.g., 2-to-4 wire hybrid), and an adder or combiner 48. The adder 48 may or may not be an actual physical component of the system 1 of FIG. 1, depending on the design of the system 1, and represents that an electrical echo signal resulting from the hybrid 46 and signals outputted by the microphone 33 are combined. Although the modules 44 are shown in FIGS. 3 and 4 in conjunction with components 32, 33 (FIG. 3) and 33, 46, 48 (FIG. 4), it should be noted that the modules 44 may or may not necessarily be physically adjacent to those components as long as the module 44 can have access to two signals x(k) and y(k), wherein in FIGS. 3 and 4, x(k) and y(k) represent signal samples where k is the sample time index, as will be described in more detail below. It also should be noted that the modules 44 of FIG. 3 or FIG. 4 may be any of those described above in connection with FIGS. 1 and/or 2, and can include a VAD 44′, although for convenience this is not shown in FIGS. 3 and 4. Furthermore, module 44 is capable of detecting any type of echo, whether acoustic or electrical without any prior knowledge of the type of echo that the module 44 is expected to detect. In a case where there is more than one echo present in a signal, be it acoustic, electrical, or a combination of electrical and acoustic echoes, the echo detection method of this invention preferably detects the echo with the most prevalence among all echoes that are present in the signal.

In each of FIGS. 3 and 4, a far-end signal is denoted x(k), and represents an electrical communication signal (including, e.g., desired and undesired audio signals such as user speech, noise, etc.), transmitted in a communication path during an established call, wherein in the case of FIG. 3, the signal x(k) is destined to be outputted by a speaker 32 of a receiving user communication terminal. A near-end signal is denoted y(k) in FIGS. 3 and 4, and is composed of an electrical (communication) signal representation of a near-end audio signal v(k) (e.g., speech and/or other audio signals desired to be transmitted as part of a call), together with an electrical signal representation of near-end audio noise n(k) and a signal xₑ(k) representing an echo of far-end signal x(k). The echo signal xₑ(l) shown in FIG. 3 includes audible acoustic signals outputted by the speaker 32 and fed back into the microphone 33 as a result of, for example, surrounding echo-contributing acoustic conditions, the design/construction of the terminal 30 and the like as described above. The echo signal xₑ(k) shown in FIG. 4, on the other hand, is an electrical echo that results from signal x(k) interacting with electrical hybrid 46 (e.g., an impedance mismatch between a 2-to4 wire conversion hybrid can cause echo signal xₑ(k).

In the echo detection procedure of the invention, performed by a module 44, the signals x(k) and y(k) are first segmented into frames of a predetermined duration, such as, for example, 20 msecs, and at an update rate of, for example, 10 msecs. A delay line of L bins is provided (e.g., in module 44 and/or memory 40) for storing the segmented frames or corresponding frame feature vectors of signal x(k), where L depends on the largest echo path delay that is expected to be detected, and where the echo path delay is considered to be defined as the amount of time difference between the time when a given segment of the far-end signal x(k) is inputted into module 44 and the time when a corresponding echo of the given segment of the far end signal x(k) reaches the module 44. This delay depends on many factors including for example, whether the echo is electrical or acoustic. It also depends, in the case of module 44 being deployed as a network node, as shown in FIG. 1, on any delays that a network might introduce. Each bin of the delay line L represents a respective delay range. For example, according to one embodiment of the invention, a first bin stores a first segmented frame representing the first 20 msecs (0 to 20 msecs) of the signal x(k), a second bin stores a second segmented frame representing another 20 msecs (10 to 30 msecs) of the signal x(k), etc., such that there is a 10 msec overlap (due to 10 msec update rate and 20 msec frame duration) between the frames stored in adjacent bins. Of course, in other embodiments of the invention, each bin may store frames of a different duration than that described above, and the update rate may be different as well.

Next, a set of spectral parameters is computed for each frame in the delay line L as well as for the current y(k) frame (initially the first frame of the signal y(k)). A similarity function is defined to measure the similarity between a given y(k) frame and each frame in the bins of the delay line L. Assuming that fᵢ(m) is the similarity function between the m^{th} frame of signal y(k) and the frame in the i^{th} bin of the delay line, where 1 [symbol] i [symbol] L, then the similarity function f₁(m) is defined as
fᵢ(m)=f(Xᵢ, Yₘ) (1)
where Xᵢ is a feature vector representing predetermined parameters extracted from the frame in the i^{th} bin of the delay line L for signal x(k), and Yₘ represents a feature vector for the m^{th} frame of signal y(k). If an echo is present in a given y(k) signal frame, then the similarity function between the frame in the delay line bin corresponding to the echo delay and the y(k) frame will consistently exhibit a larger value compared to other similarity functions computed for the rest of the delay line bins. A short or long term average of fᵢ(m) across the index m, when plotted as a function of the index i (wherein 1 [symbol] i [symbol] L), will exhibit a peak at the index that corresponds to the echo path delay in the near-end signal y(k). A threshold can be applied to either the instantaneous f(m) or the averaged (smoothed) version of fᵢ(m) to detect potential echoes. The echo path delay also can be readily estimated from delay line bin index i, where
i=argᵢ max fᵢ(m). (2)

One way to view the above approach is to relate it to speech recognition. For example, in speech recognition, a statistical model is trained for each word or phrase in an applicable vocabulary set. In the present invention, on the other hand, the model for a given word or phrase (i.e., a given delay line bin) is not statistical, but rather the exact set of frames that pass by that bin in the delay line L. The unknown signal to be recognized is the near-end signal y(k). As in speech recognition, a partial or total cumulative score of the similarity function between the model and the unknown signal is calculated, but in the present invention the calculation is used to determine if there is a match that indicates the presence of an echo, and if so, the echo path delay.

In another embodiment of the present invention, the similarity function of equation (1) is replaced by a distance function which is used instead of equation (1). If a distance function is used, such as an L1 or L2 norm, then a short or long term average of fᵢ(m) across the index m, when plotted as a function of the index i (where 1 [symbol] i [symbol] L), exhibits a minimum at the index that corresponds to the echo path delay in the near-end signal y(k). A threshold can be applied to either the instantaneous fᵢ(m) or the averaged (smoothed) version of fᵢ(m) to detect potential echoes. The echo path delay also can be readily estimated from delay line bin index i* given in equation (2)

Similarity Function Derivation

Derivation of the above-described similarity function fᵢ(m) will now be described. The present invention employs to advantage some advances that have been made in speech recognition technology, but in the context of echo detection. Specifically, one significant issue in speech recognition is what set of features to use so that the recognition results are somewhat immune to convolutional and additive noise components. Analogously, in the present echo detection context, it is desired to recognize the unknown signal y(k) from the model signal, x(k), where signal y(k), in the presence of echo, includes a version of the signal x(k) that has been corrupted by both convolutional-type noise components representing a significant portion of the echo characteristics, and additive noise components representing near-end noise and/or near-end speech or other additive audio noise.

In speech recognition, the use of features based on the Mel-Frequency Cepstral Coefficients (MFCCs) is widespread (see, e.g., the publications [4] and [5] identified in the LIST OF REFERENCES section below). Further, the augmentation of MFCCs. with their first and second order derivatives (i.e., delta and delta-delta cepstral coefficients) has been shown to improve accuracy (see publication [5]). These delta and delta-delta dynamic features are inherently robust against convolutional noise due to their very definition. Since an echo can be approximated over short segments as a linearly filtered version of the far-end signal, these dynamic features are well suited for echo detection. Therefore, according to a presently preferred embodiment of the invention, the feature vector that is employed includes twelve MFCCs, and their first and second order derivates (twelve each) for a total of thirty-six features, although in other embodiments, other suitable types of feature vectors may be used instead, and an energy parameter may also be used as a feature. Also according to a presently preferred embodiment of this invention, a window is applied to the frame samples prior to the computation of the feature vector described above. In this invention, the window type that preferably is used is a Hamming window, although other suitable window types can be used instead.

It has been known that using cepstral correlations as a similarity measure is robust against additive noise and outperforms spectral distance measures based on the L2 norm (see, e.g., publication [6] listed under the LISTED REFERENCES section below). It was further shown in publication [6] that cepstral vectors with large norms are more immune to additive noise than cepstral vectors with small norms. Therefore, according to an aspect of the present invention, the similarity function is defined as a correlation coefficient between Xᵢ and Yₘ weighted by the norm of Xᵢ, as follows:
fᵢ(m)=|Xᵢ|r(Xᵢ, Yₘ) (3)
where r(Xᵢ, Yₘ) is the correlation coefficient given by the following equation:

$$r ( {X}_{i} , {Y}_{m} ) = \frac{{X}_{i}^{T} {Y}_{m}}{\vert {X}_{i} \vert \vert {Y}_{m} \vert} . \qquad ( 4 )$$

In speech recognition, the cepstral coefficients are typically liftered before a recognition distance function is computed. The variance of the cepstral coefficients tends to decrease with increasing frequency index (see, e.g., publication [7] listed in the LIST OF REFERENCES section below). Cesptral liftering typically takes the form of normalizing the cepstral coefficients by their variance so as to substantially equalize a contribution of each coefficient in the recognition distance function. The method of the present invention normalizes each feature in the feature vector by its respective variance, according to a preferred embodiment of the invention. Feature vector variance can be predetermined using, for example, an offline speech database, or, in the case of processing signals x(k) and y(k) in a batch mode, by computing the feature variance over all frames with speech activity in the two signals x(k) and y(k). The variance can also be estimated in real-time, on a frame-by-frame basis, by updating the variance estimate as new x(k) and y(k) frames arrive. In this situation, the estimation process starts with an initial estimate and then updates it as new x(k) and y(k) frames arrive, and then uses this new updated estimate to normalize the x(k) and y(k) feature vectors of the new frame. This real-time method, or a predetermined variance computed off-line on a database, are useful if the echo detection method described herein is to be used as part of a system that requires the processing of signals in real-time, such as echo control, echo suppression, or echo cancellation systems. The flow diagram of FIG. 5 (to be described below) shows variance estimation done in real-time, although it also is within the scope of this invention to use other feature vector variance determination techniques as well, such as those referred to above. The experimental results described below were obtained using the batch method of estimating the variance. However, regardless of the method used to estimate the variance, the estimation preferably is only carried out for frames with speech or other predetermined activity. Frames with speech or other predetermined activity are frames which are deemed to be not silence, or not noise. To determine frames that have speech activity a VAD preferably is employed on both x(k) and y(k), as described above. If a predetermined variance computed off-line on a suitable database (not shown) is employed, then the VAD can be used off-line (i.e., not part of module 44) on the database to determine frames that have speech or other predetermined activity.

With variance normalization, the similarity function in equation (3) can be written as

$${f}_{i} ( m ) = \frac{{X}_{i}^{T} {U}^{- 1} {Y}_{m}}{\vert {U}^{- 1 / 2} {Y}_{m} \vert} \qquad ( 5 )$$

where U is a diagonal covariance matrix (e.g., feature vector variance).

Having described the similarity function derivation, the echo detection method according to a preferred embodiment of the present invention will now be described in further detail, wherein according to one embodiment of the invention, the method is performed during a call established between, for example, two or more terminals 2a, 2b. The method may be performed by one or more predetermined echo detection modules 44 that, in the above-described manner, are provided with communication signals traversing a communication path through which the call is effected, and such module(s) 44 may be either within the terminals 2a, 2b or elsewhere in the system 1. The method is depicted in the flow diagram of FIG. 5.

At blocks A1 and A6, a far-end signal x(k) and near-end signal y(k), respectively (FIG. 3 or 4), communicated during the call, are segmented into frames in the above-described manner. Then, at blocks A1-a and A6-a, a window is applied to the frames obtained in blocks A1 and A6, respectively, preferably using a known Hamming window or another suitable window type, and an initial (or next) frame resulting from each of blocks A1 and A6 is selected for processing.

At blocks A2 and A7, MFCCs (e.g., twelve coefficients) are computed for the segmented frame resulting from the blocks Al-a and A6-a, respectively. Thereafter, the MFCCs calculated for each respective frame in blocks A2 and A7 are employed to compute delta and delta-delta MFCCs at blocks A3 and A8, respectively. Preferably, the computations of the MFCCs in blocks A2 and A7 are performed according to procedures described in publication [4], and the computations of the delta and delta-delta MFCCs is blocks A3 and A8, are performed according to procedures described in publication [5], each of which publications [4] and [5] is incorporated by reference herein in its entirety, as if fully set forth herein. By example, in the preferred embodiment of this invention, the specific computation used for computing the cepstral coefficients (blocks A2 and A7) follows equation 5.62 described at page 24 of publication [4], and the specific computation used for computing the delta cepstral coefficients (blocks A3 and A8) follows equation (1) described in section 2.1 of publication [5]. The computation of delta-delta cepstral coefficients in blocks A3 and A8 preferably also follows equation (1) described in publication [5], but operating on the delta coefficients rather than the cepstral coefficients. In other embodiments of the invention, other variations on the computation of the MFCC and the delta and delta-delta coefficients may be employed.

At block A4, a feature vector X for a current frame from signal x(k) is formed, and in similar manner, a feature vector Yₘ for a current frame from signal y(k) is formed at block A9, where m represents the frame index of the current frame of the signal y(k). Given that in the preferred embodiment twelve cepstral coefficients, twelve delta cepstral coefficients and twelve delta-delta cepstral coefficients were computed as described above, each feature vector is formed preferably by concatenating these three sets of coefficients, resulting in a 36^{th} dimensional feature vector, although in other embodiments the feature vectors may be formed in other suitable manners.

Then, at block A5 the delay line of feature vectors is updated with the feature vector Xᵢ obtained in block A4, where i=1, L and L equals a predetermined maximum delay line index. That is, the feature vector delay line is updated with the newly obtained vector Xᵢ from block A4. For example, according to one embodiment of the invention, this updating may be performed by inputting the vector obtained in block A4 into a FIFO (not shown) and removing an oldest-stored vector from the FIFO.

Referring now to blocks A20, A22, and A24 in FIG. 5, those blocks will now be described. According to a preferred embodiment of the invention, the frame resulting from block Al-a is applied to a VAD 44′ in block A20 to determine if the frame includes speech activity (or another predetermined type of audio activity), and, in a similar manner, the frame resulting from block A6-a is applied to a VAD 44′ in block A22 to make the same determination for that frame. Then, at block A24 the results of the determination made in blocks A20 and A22 are used to compute a feature vector variance based on those results, and the computed feature vector variance is then used in the performance of block A10, which will be described below. Preferably, blocks A20 and A22 are performed according to the procedures described in publication [8] identified in the LIST OF REFERENCES section below, although in other embodiments, other suitable types of procedures can be used instead. Publication [8] is incorporated by reference herein in its entirety, as if fully set forth herein.

After blocks A5, A9 and A24, the similarity function fᵢ(m) between Xᵢ and Yₘ is calculated at block AI0 using, in a preferred embodiment, equation (5) above, for each vector Xᵢ (i=1, L) in the delay line with respect to the current vector Yₘ, where U in equation (5) is the feature vector variance computed in block A24. For example, in a case where L=50, performance of block A10 results in 50 similarity function values being obtained, each corresponding to a respective one of the frames from signal x(k) and the current frame from signal y(k). At block A11, smoothing is applied to the similarity function fᵢ(m) values calculated in block A10, to calculate a result fᵢ(m). According to a preferred embodiment of the invention, the smoothing procedure in block A11 is performed using the following equation (6), although in other embodiments other suitable smoothing functions may be employed instead:
fᵢ′(m)=αfᵢ′(m−1)+(1+α)fᵢ(m) (6)
where fᵢ′(m) is the smoothed similarity function, and a is a constant set to 0.95.

Block A11 results in smoothed similarity functions, one for each delay bin, i, 1<=i<=L

At block A12, it is determined whether either (a) any of the similarity function fᵢ(m) values obtained in block A10 is greater than a first predetermined threshold (thr1), or (b) any one of the smoothed similarity function values fᵢ(m) obtained in block A11 is greater than a second predetermined threshold (thr2), wherein if the threshold is exceeded in either case, an echo has been detected in the communication path. If block A12 results in a determination of “No”, meaning that no echo has been detected, then control passes to block A12-a where an indication is made that no echo has been detected in the current frame m of the near-end signal y(k). Control then passes to block A18 where, if the call has been discontinued (“Yes” in block A18), control then passes to block A19 and the method is terminated. If the call is maintained, on the other hand (“No” in block A18), then control passes to blocks A1-a and A6-a where the method is continued in the above-described manner for a next one of the frames originally segmented at blocks A1 and A6.

If block A12 results in a determination of “Yes”, meaning that an echo has been detected, then control passes to block A13, where an echo delay index i* is determined using, in a preferred embodiment of the invention, equation (2) above. The result of equation (2) indicates the bin storing a value that maximizes the similarity function fᵢ(m).

At block A14, an estimated echo delay is computed based on the following equation (7)
echo delay=i*.d (7)
where d represents the frame update rate (e.g., 10 msecs).

Thereafter, at block A15, it is determined whether either (a) any of the similarity function fᵢ(m) values obtained in block A10 is greater than a third predetermined threshold (thr3), or (b) any one of the smoothed similarity function values f′ᵢ(m) obtained in block A11 is greater than a fourth predetermined threshold (thr4), wherein if the threshold is exceeded in either case (“Yes” in block A15), then the condition detected previously in block A12 is confirmed to be an echo in a non-double talk condition rather than an echo in a double talk condition. If block A15 results in a determination of “No”, meaning that the condition detected in block A12 is an echo in a double talk condition, control passes to block A16 where the detection of that echo in double-talk condition is reported/indicated. According to a preferred embodiment of the invention, at block A16 an indication is made that there is a double talk condition echo included in the near-end signal y(k), particularly in the frame m associated with the bin delay index i* that maximized the similarity function fᵢ(m), and the associated echo delay value obtained in block A14 is reported. For example, in the case where the module 44 that performed the determination in block A14 is in the terminal 30 of FIG. 2, the indication and value may be reported in representative information that is provided to another module in charge of suppressing or canceling echoes and/or to some other predetermined destination. As another example, in a case where the module 44 that performed the determination in block A14 is a module 44 that is elsewhere in the system 1 besides within a terminal 30, the module 44 forwards the information through the system 1 to at least one predetermined destination, such as to a local server or other destination, such as one that, for example, performs a Quality of Service measurement. The information may also be forwarded to another system (not shown) that performs echo suppression and/or cancellation procedure, or, in another embodiment, that procedure may be performed by the module 44 itself. Thereafter, control passes back to block A1 8 where the procedure then continues therefrom in the above-described manner.

If block A15 results in a determination of “Yes”, meaning that an echo in a non-double talk condition has been detected, then control passes to block A17, where the detection of an echo condition in non-double talk is reported/indicated in a similar manner as described above with respect to, for example, block A16. Control then passes back to block A18 where the procedure then continues in the manner described above.

The determination of whether the condition detected is an echo in single talk or an echo in double talk is significant because if double talk is detected, then preferably suppression of a signal with echo in double talk speech should either be avoided, or done in such a way that the attenuation of the signal is small so as not to over-suppress the near-end speech. If the detected condition is an echo during single talk, however, then, according to one embodiment of the invention, the method can include, as part of block Al7, reducing or substantially minimizing the echo condition by attenuating the current frame of y(k) by an attenuating factor that, for example, can be a function of the results of block A13 and the frames of x(k) in the delay line. Other ways of determining the attenuating factor also may be employed, such as, for example, use of a predetermined attenuating factor. In other embodiments, the results obtained in blocks A14 and A17 (and/or A16) can be used in a predetermined manner in a monitoring application to, for example, measure network voice path quality. The reduction or substantial minimization of the echo can be performed by the module 44 or by another, suppression module in the system 1, depending on predetermined operating criteria.

Although the flow diagram of FIG. 5 has been described in the context of the feature vector variance (block A24) being computed on a frame-by-frame basis, in other embodiments a feature vector variance can be computed over all frames of the call signals in a batch mode, and then the computed variance for the total frames can be employed as variable U in equation (5) during the performance of block A10, in the above-described manner.

Also, although the flow diagram of FIG. 5 has been described in the context of a predetermined similarity function being performed at block A10, according to another embodiment of the invention, block A10 may include performing a predetermined distance function instead of a similarity function. In this embodiment of the invention, the distance function preferably is an L1 or L2 norm of the difference between feature vectors resulting from blocks A5 and A9, although in other embodiments other suitable distance functions may be employed instead. The difference can also be normalized by the variance. As an example in which the L2 norm of the difference vector is employed with variance normalization, then a distance function D, (m) that is employed in block A10 in place of the similarity function (5) is as follows:
Dᵢ(m)=−(Xᵢ−Yₘ)^{T}U⁻¹(Xᵢ−Yₘ) (8)
As can be appreciated in view of the present description, in the embodiment in which a distance function is employed, Dᵢ(m) is substituted for fᵢ(m), Dᵢ′(m) is substituted for fᵢ′(m), and Dᵢ′(m−1) is substituted for fᵢ′(m−1), in applicable procedures described herein (see, e.g., blocks A11, A12, and A15, and equations (2) and (6)). According to another embodiment of the present invention, variance normalization need not be employed, and thus blocks A20, A22, and A24 are not performed at all, whether block A10 performs the similarity function or the distance function. The matrix U in the functions (5) and/or (8) becomes the identity matrix in this case.
Experimental Results

To confirm effectiveness of the echo detection method of this invention, a system (not shown) was set up where actual echoes over a commercial 2G GSM network could be recorded. At random, six sentences spoken by a female speaker were selected, recorded, and concatenated with a period of silence after each sentence. The system enabled an audio file to be played to a mobile handset over an actual call within the GSM network. Any echo suppression within the network was turned off. Then, any echoes that returned from the mobile handset operating in non-speaker-phone mode were recorded. In this setup, no electrical echoes were possible and any echoes recorded were purely acoustic owing to, among other factors, the design/construction of the mobile phone. Furthermore, owing to typical 2G GSM network architecture, the recorded echoes were understood to have gone through a double encoding/decoding using the GSM voice codec, before arriving at the recording station. Therefore, because of the acoustic nature of the echoes, and the tandem encodings, there existed a significant degree of non-linearity in the recorded echoes.

To generate different echo conditions, the recorded echoes were scaled to a desired level and shifted to a predetermined echo path delay. The result was then mixed with near-end noise and/or speech to simulate a typical near-end signal y(k). The similarity function was then computed, using equation (5), over 20 msec frames that were updated every 10 msecs, resulting in a 10 msec granularity in estimating the echo path delay.

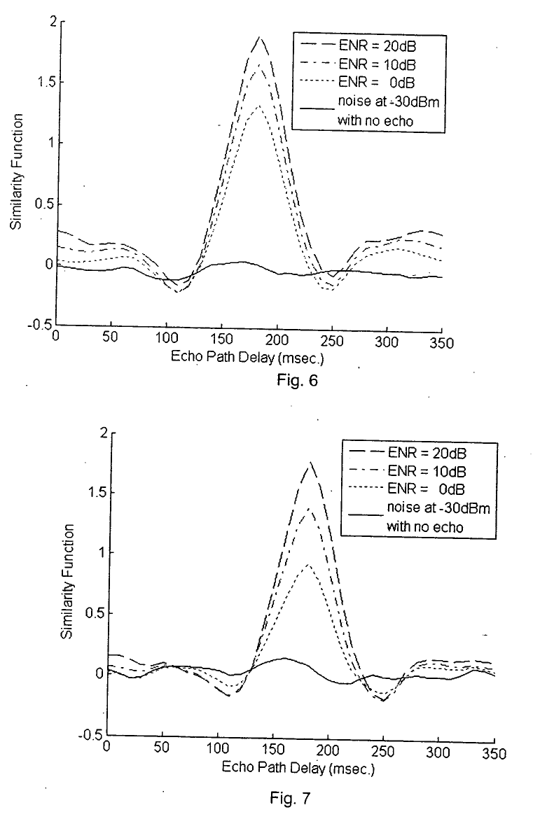

FIGS. 6 and 7 show plots of the calculated similarity function values versus echo path delay. The similarity function value at any given delay represents the mean value over the six-sentence utterance. However, to remove any bias caused by including silence periods in the averaging process, a VAD was employed to identify non-silence periods in the far-end signal x(k). The similarity function mean was then computed only over non-silence periods as determined by the VAD. The specific VAD used in the experiment is the VAD (Option 1) that is part of the 3GPP specification for the 12.2 kpbs Enhanced Full Rate coder (see, e.g., the publication [8] listed in the LIST OF REFERENCES section below). In FIGS. 6 and 7, the far-end signal level is −17 dBm, and the Echo Return Loss (ERL) in the near-end signal is 25 dB. The echo path delay is 175 msecs. The near-end signal was constructed by mixing the echo signal with different types of noises at varying Echo-to-Noise ratios (ENRs). As a baseline, FIGS. 6 and 7 also represent a case where there is only noise at −30 dBm, and no echo in the near-end signal. FIG. 6 shows the results when the near-end noise was recorded in a car driving on a highway, while FIG. 7 shows the results when the noise was recorded in a crowded shopping mall.

It is clear from FIGS. 6 and 7 that even at a low ENR, the echo detection method of the invention results is a clear peak at the correct echo path delay. Compared with the case of no echo, it is evident that a reasonable threshold can be applied to detect echoes and estimate the echo path delay correctly. It is useful to note also that the mall noise has a significant component of speech-correlated noise. Nevertheless, the detection method is able to accurately identify the echo, although the peak values at the correct echo path delay are somewhat smaller than for the case when the noise is car noise. Also, the difference in the peak value at different ENRs is larger in the case of mall noise compared to the car noise case. This can be due to the fact that the mall noise has speech-correlated noise.

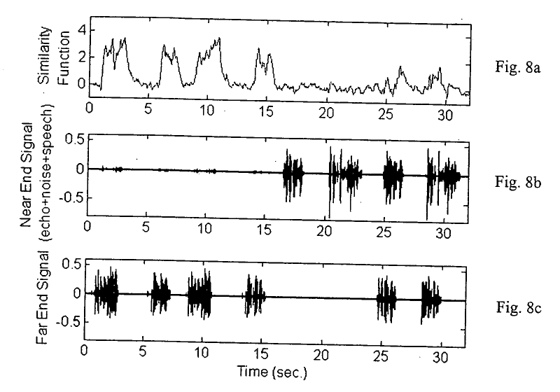

FIG. 8a shows an example of the behavior of the similarity function during periods of single-talk, double-talk, and no speech. In FIG. 8a, the function is plotted as a function of the time index m. FIG. 8b represents the near-end signal, while FIG. 8c represents the far-end signal. The near-end signal was constructed by mixing the following three signals:
i. Echo of the far-end at 25 dB ERL and 175 msec delay.
ii. Near-end car noise at Echo-to-Noise ratio of 5 dB.
iii. Near-end speech at −17 dBm.

The near end speech starts at around 17 seconds into the signal and consists of four sentences spoken by a male speaker. The first two sentences do not overlap with far end speech, while the last two sentences do overlap, producing a double-talk condition. FIG. 8a represents a smoothed version of the similarity function fᵢ(m) at index i, wherein the smoothed function is function fᵢ′(m) obtained using equation (2) above. In FIG. 8a it can be seen that, in comparing regions where there is echo to regions where there is only near-end noise or near-end noise plus near-end speech, the smoothed similarity function is able to discriminate extremely well between echo and non-echo regions. Furthermore, when comparing double-talk regions to single-talk regions, it can be seen that the similarity function values are lower than the values in regions where only the far end is talking and higher in regions where there is no echo. These results demonstrate that with proper threshold settings, the similarity function can effectively detect echoes as well as double-talk conditions.

The foregoing description describes a method for echo detection and echo path delay estimation using a pattern recognition approach. Echo detection is performed by matching an audio (e.g., speech) pattern in a near-end signal to that in a far-end signal at a given delay. Adapting features and techniques that have been used successfully in speech recognition and applying them to the echo detection context, a spectral similarity function based on cepstral correlation is defined according to the invention. The above-described experimental results show that the proposed similarity function can reliably detect acoustic echoes and correctly estimate the echo path delay. Further, it is shown that the similarity function can be used in the detection of echoes during double-talk conditions. The method presented herein is applicable to both electrical (hybrid) network echoes as well as to acoustic echoes. An algorithm according to the invention employs the above echo detection method and similarity function to determine if a call has objectionable echoes and if so, to estimate the echo path delay. According to another embodiment of the invention, a predetermined distance function is employed instead of the similarity function.

While the invention has been particularly shown and described with respect to preferred embodiments thereof, it will be understood by those skilled in the art that changes in form and details may be made therein without departing from the scope and spirit of the invention.

### LIST OF REFERENCES

[1] J. Benesty, T. Gansler, D. R. Morgan, M. M. Sondhi, and S. L. Gay, Advances in Network and Acoustic Echo Cancellation, Springer-Verlag, Berlin, 2001, pp. 1-74.

[2] E. Hansler and G. Schmidt, Acoustic Echo and Noise Control. A practical Approach, Wiley, New Jersey, 2004, pp. 1-262.

[3] F. Kuech, A. Mitnacht, W. Kellermann, “Nonlinear Acoustic Echo Cancellation Using Adaptive Orthogonalized Power Filters,” in Proc. Int. Conf on Acoustics, Speech, and Signal Processing (ICASSP), pp. 18-23, Vol. 3, March 2005.

[4] ETSI, “ETSI ES 202 050 V.1.1.4, Speech Processing, Transmission and Quality Aspects (STQ); Distributed Speech Recognition; Advanced Front-End Feature Extraction Algorithm; Compression algorithms,” October 2005, pp. 21-24.

[5] B. Milner, “Inclusion of Temporal Information Into Features for Speech Recognition,” Proc. Int. Conf on Spoken Language Procession (ICSLP), pp. 21-24, Vol. 1, October 1996.

[6] D. Mansour, and B. H. Juang, “A Family of Distortion Measures Based Upon Projection Operation for Robust Speech Recognition,” IEEE Trans. Acoustics, Speech, and Signal Processing, pp. 1659-1671, Vol. 37, November 1989.

[7] B. H. Juang, L. R. Rabiner, and J. G. Wilpon, “On the Use of Bandpass Liftering in Speech Recognition,” IEEE Trans. Acoustics, Speech, and Signal Processing, pp. 947-954, Vol. 32, July 1987.

[8] 3^{rd} Generation Partnership Project, “3GPP TS 26.094 V6.0.0, Voice Activity Detector (VAD),” December 2004, pp. 5-15 (Release 6).

What is claimed is:

1. A method for evaluating communication signals exchanged between communicating devices through at least one communication path, comprising:
performing a predetermined function computation to determine if the communication signals include at least one substantially similar pattern; and
reporting an existence of a predetermined condition if it is determined in the performing that the communication signals include a substantially similar pattern.

2. A method as set forth in claim 1, wherein the predetermined condition is an echo condition.

3. A method as set forth in claim 1, wherein the predetermined condition is an echo in a double talk condition.

4. A method as set forth in claim 2, wherein the echo condition is acoustical or electrical in origin.

5. A method as set forth in claim 3, wherein the echo condition is acoustical or electrical in origin.

6. A method as set forth in claim 1, wherein the substantially similar pattern is a speech pattern.

7. A method as set forth in claim 1, further comprising:
segmenting, into first frames, at least one first communication signal traveling from a first one of the communicating devices to a second one of the communicating devices through the at least one communication path;
segmenting, into second frames, at least one second communication signal traveling from the second one of the communicating devices to the first one of the communicating devices through the at least one communication path;
forming a first feature vector based on at least one of the first frames; and
forming a second feature vector based on at least one of the second frames,
wherein the predetermined function is performed based on the first and second feature vectors.

8. A method as set forth in claim 7, further comprising calculating cepstral coefficients based on the at least one first frame and the at least one second frame, wherein the forming of the first feature vector is performed based on cepstral coefficients calculated based on the at least one first frame, and the forming of the second feature vector is performed based on cepstral coefficients calculated based on the at least one second frame.

9. A method as set forth in claim 7, further comprising calculating cepstral coefficients and delta cepstral coefficients based on the at least one first frame and the at least one second frame, wherein the forming of the first feature vector is performed by concatenating the cepstral and delta cepstral coefficients calculated based on the at least one first frame, and the forming of the second feature vector is performed by concatenating the cepstral and delta cepstral coefficients calculated based on the at least one second frame.

10. A method as set forth in claim 7, further comprising calculating cepstral coefficients and delta cepstral coefficients and delta-delta cepstral coefficients based on the at least one first frame and the at least one second frame, wherein the forming of the first feature vector is performed by concatenating the cepstral and delta cepstral and delta cepstral coefficients calculated based on the at least one first frame, and the forming of the second feature vector is performed by concatenating the cepstral and delta cepstral and delta delta coefficients calculated based on the at least one second frame.

11. A method as set forth in claim 8, wherein the cepstral coefficients are Mel-Frequency Cepstral Coefficients.

12. A method as set forth in claim 8, wherein the cepstral coefficients are first and second order derivatives of Mel-Frequency Cepstral Coefficients.

13. A method as set forth in claim 1, wherein the predetermined function computation is one of a similarity function and a distance function.

14. A method as set forth in claim 13, wherein the similarity function is defined as follows:
$${f}_{i} ( m ) = \frac{{X}_{i}^{T} {U}^{- 1} {Y}_{m}}{\vert {U}^{- 1 / 2} {Y}_{m} \vert}$$
where f(m) represents the similarity function, U is a diagonal covariance matrix, Xᵢ is a first feature vector based on one of the communication signals, and Yₘ is a second feature vector based on another one of the communication signals.

15. A method as set forth in claim 13, wherein the distance function is one of a L1 norm and a L2 norm.

16. A method as set forth in claim 2, further comprising determining an estimated echo delay based on a result of the performing of the predetermined function computation.

17. A method as set forth in claim 2, wherein a first one of the communication signals includes an echo of at least part of a second one of the communication signals, and the pattern represents the echo.

18. A method as set forth in claim 17, wherein the echo results from the second one of the communication signals interacting with an electrical hybrid component included in the at least one communication path.

19. A method as set forth in claim 17, wherein the echo results from at least the part of the second communication signal being fed back into an input interface of one of the communicating devices, after having been outputted through an output interface of that communicating device.

20. A method as set forth in claim 2, further comprising reducing the echo condition.

21. A method as set forth in claim 7, further comprising computing a feature vector variance based on the at least one of the first frames and the at least one of the second frames, and wherein the predetermined function computation is performed based also on the feature vector variance.

22. A detection module arranged to evaluate communication signals exchanged between communicating devices through at least one communication path, the detection module comprising at least one input and at least one output, wherein the detection module performs a predetermined function computation to determine if the communication signals applied to the at least one input include at least one substantially similar pattern, and reports through the at least one output an existence of a predetermined condition if it is determined that the communication signals include a substantially similar pattern.

23. A detection module as set forth in claim 22, wherein the predetermined condition is an echo condition.

24. A detection module as set forth in claim 23, wherein the echo condition is acoustical or electrical in origin.

25. A detection module as set forth in claim 22, wherein the predetermined condition is an echo condition, and wherein the method further comprises determining an estimated echo delay based on a result obtained by performance of the predetermined function computation.

26. A detection module as set forth in claim 22, wherein the predetermined function computation is one of a similarity function computation and a distance function computation.

27. A user communication device, comprising:
a communication interface, bidirectionally coupled to an external interface, to receive an incoming communication signal by way of the external interface, and to transmit an outgoing communication signal by way of the external interface; and
a controller bidirectionally coupled to the communication interface, and including a detection module to identify whether an echo is present based on the incoming and outgoing communication signals.

28. A user communication device as set forth in claim 27, wherein the detection module identifies whether the echo is present by performing one of a similarity function and a distance function.

29. A user communication device as set forth in claim 28, wherein the similarity function is defined as follows:
$${f}_{i} ( m ) = \frac{{X}_{i}^{T} {U}^{- 1} {Y}_{m}}{\vert {U}^{- 1 / 2} {Y}_{m} \vert}$$
where f(m) represents the similarity function, U is a diagonal covariance matrix, Xᵢ is a first feature vector based on the incoming communication signal, and Yₘ is a second feature vector based on the outgoing communication signal.

30. A user communication device as set forth in claim 27, wherein the user communication device comprises at least one of a telephone and a radiotelephone.

31. A user communication device as set forth in claim 27, further comprising:
at least one output user interface having an input coupled to an output of the controller, the controller forwarding the incoming communication signal received at the communication interface to the output user interface for being outputted thereby; and
at least one input user interface having an output coupled to an input of the controller,
wherein the echo occurs as a result of at least a portion of an output of the output user interface feeding back into the user communication device through the input user interface and becoming at least part of the outgoing communication signal.

32. A user communication device as set forth in claim 27, wherein the detection module also determines an estimated echo delay in a case in which an echo is identified.

33. A communication system, comprising:
at least one communication path; and
a plurality of user communication devices exchanging communication signals through the at least one communication path,
wherein one or more of the at least one communication path and the user communication devices comprises:
a detection module that performs a predetermined function computation to determine if the communication signals include at least one substantially similar pattern, and which reports an existence of a predetermined condition if it is determined that the communication signals include a substantially similar pattern.

34. A communication system as set forth in claim 33, wherein the predetermined condition is an echo condition.

35. A communication system as set forth in claim 34, wherein the echo condition is acoustical or electrical in origin.

36. A communication system set forth in claim 33, wherein the detection module also determines an estimated echo delay based on a result of performing the predetermined function computation.

37. A communication system as set forth in claim 33, wherein the predetermined condition is an echo condition, and the at least one communication path comprises at least one electrical hybrid causing the echo condition.

38. A program embodied in a computer-readable medium, the program comprising computer-executable instructions for performing a method to evaluate communication signals exchanged between communicating devices through at least one communication path, the instructions comprising:
code to perform a predetermined function computation to determine if the communication signals include at least one substantially similar pattern; and
code to report an existence of a predetermined condition if it is determined that the communication signals include a substantially similar pattern.
